(19) United States
(12) Patent Application Publication
(10) Pub. No.: US 2016/0338373 A1
(43) Pub. Date: Nov. 24, 2016

(54) PALM PHENOLICS AND FLAVONOIDS AS POTENT BIOLOGICAL AND CHEMICAL ANTIOXIDANTS FOR APPLICATIONS IN FOODS AND EDIBLE OILS

(71) Applicant: MALAYSIAN PALM OIL BOARD, Kajang (MY)

(72) Inventors: YEW Ai TAN, Kajang (MY); RAVIGADEVI SAMBANTHMURTHI, Kajang (MY); KALYANA SUNDRAM MANICKAM, Kajang (MY); MOHD BASRI BIN WAHID, Kajang (MY)

(73) Assignee: MALAYSIAN PALM OIL BOARD, Kajang (MY)

(21) Appl. No.: 15/225,469

(22) Filed: Aug. 1, 2016

Related U.S. Application Data
(63) Continuation of application No. 12/595,609, filed on Mar. 16, 2010, now abandoned.

(51) Int. Cl. A23D 9/007; A23L 3/349; A23L 3/3544

(52) U.S. Cl. CPC A23D 9/007; A23L 3/3544; A23L 3/349; A23V 2002/00

(57) ABSTRACT

This invention relates to the use of palm phenolics as natural antioxidants and food preservatives. In particular, the present invention relates to antioxidant compounds derived from a plant material, wherein the said antioxidant compounds are phenolics comprising but not confined to phenolic acids and flavonoids extracted from by-products of palm oil mill.

### FIELD OF INVENTION

This invention relates to the use of palm phenolics and flavonoids as natural antioxidants and food preservatives. It is also directed to a process for preparing an emulsion of palm phenolics which includes, but not confined to, phenolic acids and flavonoids in non-ionic substances which have both hydrophilic and lipophilic properties for use in food products and edible oils.

### BACKGROUND OF THE INVENTION

Antioxidants are substances that when present in food or in the body at low concentrations compared to that of an oxidizable substrate markedly delay or prevent the oxidation of that substrate. The role of antioxidants is to extend the shelf life of foodstuffs and to reduce wastage and nutritional losses by inhibiting and delaying oxidation. In food, antioxidants occur either as endogenous constituents or are added for enhancing product quality by controlling oxidation with its deleterious consequences. The mechanism by which antioxidants protect food from oxidation is by scavenging of free radicals via donation of an electron or a hydrogen atom, or by deactivation of metal ions and singlet oxygen. The ideal food grade antioxidant should be safe and not impart colour, odour or flavour. It should also be effective at low concentrations, be easy to incorporate into foods, survive harsh processing conditions, be stable in the finished product and available at low cost. Whilst antioxidants are often added to foods to stabilize them and prevent off-flavour development, considerable interest has been expressed for their potential role as therapeutic agents. Consequently, antioxidants are of interest to both food scientists and health professionals.

Lipid peroxidation is a problem in the edible oil and food industry as well as in the human body. Excess production of oxygen radical species, particularly hydroxyl radicals, can affect lipid cell membranes to produce lipid peroxides and reactive oxygen species which are linked to a variety of diseases as well as acceleration of the aging process. Oils and fats undergo oxidative deterioration on heating and storage and antioxidants are added to increase their shelf life by retarding the development of oxidation products. The most widely used antioxidants or oxidation inhibitors are tertiary butyl hydroquinone (TBHQ), butylated hydroxanisole (BHA) and butylated hydroxytoluene (BHT). However, several countries have now restricted the use of these synthetic antioxidants because of growing evidence on their health risks. In general, natural antioxidants are preferred by consumers and are more likely to gain legislative approval more easily. An ideal antioxidant will be from a natural source, effective at an economical concentration and imparts no undesirable flavour, haze or colour to the oil. Oxidation of lipids in food affects its nutritional quality, wholesomeness, safety, colour, flavour and texture. In the past, the use of approved synthetic antioxidants in foods has proven to be an effective and economical method of inhibiting oxidation and prolonging shelf-life. However, growing consumer concerns over the use of chemicals in foods, non-synthetic antioxidants from natural food ingredients are fast gaining the attention of food manufacturers.

Naturally occurring inhibitors of oxidation in food generally originate from plant-based materials. The active components, namely phenolics, flavonoids and polyphenolics, including tocopherols, are secondary plant metabolites and are first derived from phenylalanine and in certain cases and in some plants from tyrosine. Examples of some common plant phenolic antioxidants include flavonoid compounds, cinnamic acid derivatives, coumarins and tocopherols. Several studies are in progress to identify natural antioxidants while some such as rosemary oil extract and sesamol have already been extracted from plant sources and are produced commercially.

Antioxidants can be classified according to their mode of action. Thus, antioxidants can be free-radical terminators, chelators of metal ions, or oxygen scavengers that react with oxygen in closed systems. Primary antioxidants react with high-energy lipid radicals to convert them to thermodynamically more stable products and secondary antioxidants retard the rate of chain initiation by breaking down hydroperoxides. Phenolic antioxidants are included in the category of free radical terminators.

During the extraction of crude palm oil from oil palm (Elaeis guineensis) fruits, a large volume of aqueous waste is generated and subsequently discarded as palm oil mill effluent (POME). Oil palm fruits contain numerous phenolic compounds and most of these water-soluble components end up in the POME. This invention relates to the preparation of a composition of palm phenolics and flavonoid extracted from POME, for use as antioxidants in foods and edible oils. In order to make it the water-soluble palm phenolics and flavonoids soluble in lipid/oil systems, the palm phenolic and flavonoid extract was pre-treated with surface active agents to form an emulsion.

### SUMMARY OF INVENTION

The present invention provides a composition comprising phenolics derived from palm oil mill vegetation liquor, wherein said composition is for reducing oxidative deterioration in fats and edible oils.

In another embodiment of the present invention, there is provided a method for the

preparation of an oil soluble composition comprising extracts of phenolics derived from

vegetation liquor of palm oil mill, said method comprising the steps of a) dissolving said

extracts of phenolics in a solubilizing medium and b) admixing solution of step a) with a

surface active agent.

### DETAILED DESCRIPTION OF THE INVENTION

Palm phenolics and flavonoids extracted from palm oil aqueous by products (US Application 2003031740 (Published as U.S. Pat. No. 7,387,802) is water-soluble and fat-insoluble. Such compounds can be made into effective antioxidants for water-insoluble substrates e.g. in fats by forming emulsions or pastes in non-ionic substances which have both hydrophilic and lipophilic properties e.g. surface active agents.

The present invention further relates to the preparation of oil soluble antioxidants from a water-soluble extract of palm phenolics and flavonoids recovered from the aqueous by products of the palm oil mill or what is commonly known as palm oil mill effluent (POME). Such compounds can be made into effective antioxidants for water-insoluble substrates e.g. fats by forming emulsion or paste in non-ionic substances which have both hydrophilic and lipophilic properties e.g. surface active agents. By dissolving the extract containing palm phenolics and flavonoids in a solubilising medium, such as ethanol water and admixing this with the surface active agent, an antioxidant composition of the surface active agent and extract of the palm phenolics and flavonoids is produced for applications in edible oils and foods. An oil soluble extract containing the palm phenolics and flavonoid can also be directly prepared by pre-dissolving it in propylene glycol without the use of other solvents.

Another method for dissolving the water-soluble palm phenolics and flavonoids in oil is by solubilising the water-soluble palm phenolics and flavonoids in water and admixing this solubilisate into a mixture of oil solution containing lecithin. The amount of lecithin present in the oil is from about 0.1-0.5 weight percent. The oil is selected from a group consisting of vegetable oils, animal fats/oils, edible oils or blends thereof. When the oil is containing the lecithin is stirred after the addition of the aqueous palm phenolics and flavonoids solution, reverse micelles are formed. The water-soluble palm phenolics and flavonoids are therefore solubilised in the oil via reverse micelles.

### EXAMPLES

### Example 1

1 g of the palm phenolics and flavonoid was dissolved in 12.5 ml of ethanol containing 6 ml of water. This solution was added to 12 g of Tween 80 and the mixture homogenized.

### Example 2

0.5841 g of extract of the palm phenolics and flavonoid was mixed with 6.5 g of propylene glycol and warmed to hasten the dissolution of the extract in the propylene glycol.

### Example 3

Use of compositions of palm phenolics and flavonoids as prepared according to Example 1 and Exampled 2 to stabilize of refined palm olein (RPOo)

The refined palm olein (RPOo) used in this experiment had a free fatty acid content of 0.23%, iodine value of 57.1 and peroxide value of 15 meq/kg and induction time of 18 hours. Peroxide value (PV) is a standard test for evaluating the degree to which an oil has been oxidized while the induction time measured at 110° C. using a Rancimat apparatus is an accepted methodology for determining relative strengths of antioxidants.

1.39 g of palm phenolics and flavonoids composite of Example 1 was added to 55 g of refined palm olein in a glass sample bottle and the mixture homogenized by stirring.

1.38 g of the palm phenolics and flavonoids composite of Example 2 was added to 55 g of refined palm olein in a glass sample bottle and the mixture homogenized by stirring.

A blank control of 55 g of refined palm olein was used as comparison.

All samples were stored in oven at 70° C. for 5 weeks and were tested for peroxide value and induction times in hours using the Rancimat at 110° C. at the end of the storage period. The results presented in Table 1, demonstrate that after 5 weeks of storage at 70° C., the palm phenolic and flavonoids composites of Example 1 and Example 2 were able to retard the oxidation of the refined palm olein as compared with the blank control.

TABLE 1
PV and rancimat induction time of refined palm olein
after storage at 70° C. for 5 weeks

| time (Hr) | PV (meq/kg) | Induction |
|---|---|---|
| Control | 88 | 0 |
| RPOo + Composite of Example 1 | 51 | 1 |
| RPOo + Composite of Example 1 | 65 | 3 |

Table 1 clearly shows that the composition of palm phenolics and flavonoids of Example 1 and 2 of the present invention, when added to RPOo retard the oxidative deterioration of the oil.

### Example 4

2.5 g of soybean lecithin were added to 500 g of refined palm olein (RPOo) by stirring. After homogenizing the lecithin in RPOo, 0.25 ml of 50% (w/w) aqueous palm phenolics and flavonoids solution was added to the oil and stirred until reverse micelles of the oil are formed uniformly.

### Example 5

Comparison of the antioxidant efficacy of a composite of palm phenolics and flavonoids as prepared according to Example 4 with commercial antioxidants

The refined palm olein (RPOo) used in this example as well as in Example 4, had a free fatty acid content of 0.07%, iodine value of 56 and peroxide value of 1.2 meq/kg and induction time of 25 hours.

Peroxide value (PV) is a standard test for evaluating the degree to which oil has been oxidized. Induction period is the length of time, in hours, before the rapid acceleration of oxidation. Induction periods are also known as OSI (Oxidative stability index), defined as the point of maximum change of the rate of oxidation. The determination of the OSI in this example was carried out with the test oils held at 110° C. until the induction period is reached. The Oxidative Stability Instrument was used in this example as it can analyse 24 samples in one run while the Rancimat used in Example 3 can only test 6 samples in one run.

450 g of RPOo containing 250 mg/kg palm phenolics and flavonoids, prepared according to Example 4 was transferred into a 500-ml amber-glass bottles and loosely capped. RPOo containing 1000 mg/kg Rosemary extract (sourced from KALSEC® Inc), 175 mg/kg BHA (butylhydroxy anisole) and 75 mg/kg BHT (butylhydroxy toluene) were prepared and 450 g of each of the antioxidant fortified RPOo were stored in loosely capped 500-ml amber-coloured glass bottles. The contents of BHA and BHT in RPOo were so chosen because these are the maximum levels allowed CODEX Stan 19-1981 for fats and oils. A 450 g of RPOo without addition of any additive was used as the control blank.

All samples were stored in loosely capped 500-ml amber-coloured glass bottles to minimize exposure to light while handling the samples before, during and after the aging process. The Oven Storage Test for Accelerated Aging of Oils (AOCS Recommended Practice Cg 5-97) was used to measure the stability of test oils by aging/storing the test oils in an oven at 60° C., in the dark, to exclude photo-oxidation. Although separate storage containers are preferred for the removal of aliquots for each sampling time, aliquots from the same container were taken in example because amounts removed were small and did not affect the surface volume ratio significantly. To ensure uniform transfer of heat from the oven to the samples, placement of the bottles of samples in the oven was systematically changed after each weekly sampling.

The results presented in Table 2 and Table 3, demonstrate that after 3 weeks of storage at 60° C., the palm phenolic and flavonoids composite of Example 4 was able to retard the oxidation of RPOo as compared with the blank control. Also demonstrated in Table 2 and Table 3, is the efficacy of the palm phenolic and flavonoids composite as an antioxidant for stabilizing oil, in comparison with efficacies of commercially available rosemary extract, BHA and BHT.

TABLE 2
Change in PV of refined palm olein fortified with
different antioxidants on storage at 60° C. in the dark for 3
weeks (21 days)

| | Before | After 7 | After 14 | After 21 |
|---|---|---|---|---|
| Sample | storage | days | days | days |
| Control | 1.2 | 9.4 | 19.7 | 29.3 |
| RPOo + 250 mg/kg | 1.1 | 2.4 | 3.7 | 6.9 |
| palm phenolics | | | | |
| RPOo + 1000 | 1.1 | 5.0 | 6.2 | 9.3 |
| mg/kg rosemary | | | | |
| extract | | | | |
| RPOo + 175 mg/kg | 1.5 | 7.3 | 16.4 | 27.9 |
| BHA | | | | |
| RPOo + 75 mg/kg | 1.2 | 7.4 | 9.1 | 16.1 |
| BHT | | | | |

TABLE 3
Change in induction time of refined palm olein fortified
with different antioxidants on storage at 60° C. in the dark for 3
weeks (21 days)

| | Before | After 7 | After 14 | After 21 |
|---|---|---|---|---|
| Sample | storage | days | days | days |
| Control | 25 | 23 | 18 | 13 |
| RPOo + 250 mg/kg | 26 | 26 | 25 | 23 |
| palm phenolics | | | | |
| RPOo + 1000 | 31 | 30 | 27 | 24 |
| mg/kg rosemary | | | | |
| extract | | | | |
| RPOo + 175 mg/kg | 27 | 24 | 20 | 18 |
| BHA | | | | |
| RPOo + 75 mg/kg | 28 | 26 | 24 | 21 |
| BHT | | | | |

Although the present invention has been described with reference to the preferred embodiments and examples thereof, it is apparent to those skilled in the art that a variety of modifications and changes may be made without departing from the scope of the present invention which is intended to be defined by the appended claims.

What is claimed is:

1. A method of preparing an oil based emulsion by making water soluble palm phenolics and flavonoids from an aqueous by-product of palm oil mill effluent (POME) oil soluble, said method comprising:
dissolving a predetermined quantity of an aqueous by-product obtained from POME in a mixture of ethanol and water to obtain a solution;
adding a surface active agent to the obtained solution;
homogenizing the solution;
adding the solution to a predetermined quantity of a refined oil to obtain a mixture;
stirring the mixture; and
storing the mixture at a predetermined temperature for a predetermined time period.

2. The method according to claim 1, wherein the mixture of ethanol and water is prepared by dissolving 12.5 ml of ethanol in 6 ml of water.

3. The method according to claim 1, wherein the surface active agent is selected from the group consisting of lecithin, tween 80 or propylene glycol.

4. The method according to claim 1, wherein the refined oil is refined palm olein.

5. The method according to claim 1, wherein the predetermined quantity of refined oil is 55 g.

6. The method according to claim 1, wherein the predetermined temperature is 70° C.

7. The method according to claim 1, wherein the predetermined time period is 5 weeks.
